(19) United States
(12) Patent Application Publication
(10) Pub. No.: US 2026/0302368 A1
(43) Pub. Date: Oct. 1, 2026

(54) ELECTRODE ASSEMBLY AND SECONDARY BATTERY COMPRISING THE ELECTRODE ASSEMBLY

(71) Applicant: SAMSUNG SDI CO., LTD., Yongin-si (KR)

(72) Inventors: Eon Woo PARK, Yongin-si, Gyeonggi-do (KR); Chan Yoon JUNG, Yongin-si (KR); Je Hyun LEE, Yongin-si (KR); Ho Jin SONG, Yongin-si (KR)

(21) Appl. No.: 19/300,835

(22) Filed: Aug. 15, 2025

(30) Foreign Application Priority Data
Mar. 26, 2025 (KR) 10-2025-0038703

(51) Int. Cl. H01M 10/0587; H01M 4/02; H01M 50/105; H01M 50/249; H01M 50/538; H01M 50/593

(52) U.S. Cl. CPC H01M 10/0587; H01M 50/538; H01M 50/593; H01M 2004/021; H01M 50/105; H01M 50/249; H01M 2220/20

(57) ABSTRACT

An electrode assembly includes a first electrode; a second electrode; and a separator between the first electrode and the second electrode. The first electrode, the second electrode, and the separator are wound 4 such that the electrode assembly has a first diameter in a first direction and a second diameter in a second direction, with the second diameter being smaller than the first diameter. The first electrode comprises a first current collector including a first uncoated portion, and a first active material layer is provided on the first current collector. The second electrode comprises a second current collector including a second uncoated portion, and a second active material layer is provided on the second current collector. A first electrode tab is coupled to the first uncoated portion, and a second electrode tab is coupled to the second uncoated portion. A first insulating member covers a boundary region between the first uncoated portion and the first active material layer, a second-first insulating member surrounds the first electrode tab, a second-second insulating member surrounds the second electrode tab, and the first insulating member on the first active material layer does not overlap with the second-first insulating member in the direction of the second diameter.

### CROSS-REFERENCE TO THE RELATED APPLICATION

The present application claims priority to and the benefit of Korean Patent Application No. 10-2025-0038703, filed on Mar. 26, 2025, in the Korean Intellectual Property Office, the entire disclosure of which is incorporated herein by reference.

### BACKGROUND

### 1. Field

Embodiments relate to an electrode assembly and a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide an electrode assembly and a secondary battery having improved performance and lifespan.

The electrode assembly according to the embodiment includes a first electrode; a second electrode; and a separator between the first electrode and the second electrode, the first electrode, the second electrode, and the separator are wound such that the electrode assembly has a first diameter in a first direction and a second diameter in a second direction, with the second diameter being smaller than the first diameter, the first electrode comprises a first current collector including a first uncoated portion; and a first active material layer is provided on the first current collector, the second electrode comprises a second current collector including a second uncoated portion; and a second active material layer is provided on the second current collector, a first electrode tab is coupled to the first uncoated portion, a second electrode tab is coupled to the second uncoated portion, a first insulating member covers a boundary region between the first uncoated portion and the first active material layer, a second-first insulating member surrounds the first electrode tab, a second-second insulating member surrounds the second electrode tab, and the first insulating member on the first active material layer does not overlap with the second-first insulating member in the direction of the second diameter.

The electrode assembly includes a first region, a second region, a third region and a fourth region in the direction of the first diameter, and the thickness of the first region and the thickness of the third region is greater than the thickness of the second region and the thickness of the fourth region.

A difference between the thicknesses of the first region and the third region and the thicknesses of the second region and the fourth region is less than or equal to twice the thickness of the first insulating member.

A difference between the thicknesses of the first region and the third region and the thicknesses of the second region and the fourth region is less than or equal to twice the thickness of the second-first insulating member.

In the first region, in the direction of the second diameter, two layers of the first insulating member on the first active material layer and two layers of the first insulating member on the first uncoated portion are provided, in the second region, in the direction of the second diameter, two layers of the first insulating member is disposed are provided, in the third region, in the direction of the second diameter, two layers of the first insulating member and two layers of the second-first insulating member are disposed are provided, and in the fourth region, in the direction of the second diameter, two layers of the second-first insulating member is provided.

The electrode assembly includes fifth region is further formed in which two layers of second-second insulating members are provided in the direction of the second diameter.

The electrode assembly includes a sixth region in which two layers of second-first insulating members and two layers of the second-second insulating member are provided in the direction of the second diameter.

A first-second insulating member covers the boundary region between the second uncoated portion and the second active material layer.

The electrode assembly includes a first-second region, a second-second region, a third-second region and a fourth-second region in the direction of the first diameter, and the thickness of the first-second region and the thickness of the third-second region are greater than the thickness of the second-second region and the thickness of the fourth-second region.

A difference between the thicknesses of the first-second region and the third-second region and the thicknesses of the second-second region and the fourth-second region is less than or equal to twice the thickness of the first-first insulating member.

A difference between the thicknesses of the first-second region and the third-second region and the thicknesses of the second-second region and the fourth-second region is less than or equal to twice the thickness of the second-first insulating member.

In the first-second region, in the direction of the second diameter, two layers of the first-first insulating member on the first active material layer, two layers of the first-first insulating member on the first uncoated portion, and one or two layers of the first-second insulating member are provided, in the second-second region, in the direction of the second diameter, two layers of the first-first insulating member and one or two layers of the first-second insulating member are provided, in the third-second region, in the direction of the second diameter, two layers of the first-first insulating member, one or two layers of the first-second insulating member, and two layers of the second-first insulating member are provided, and in the fourth-second region, in the direction of the second diameter, one or two layers of the first-second insulating member and two layers of the second-first insulating member are provided.

The electrode assembly includes a fifth-second region in which two layers of second-second insulating members are provided in the direction of the second diameter.

The electrode assembly includes a sixth-second region in which two layers of the second-first insulating member and two layers of the second-second insulating member are provided in the direction of the second diameter.

The electrode assembly includes a first region, a second region, and a fourth region in the direction of the first diameter, and the thickness of the first region is greater than the thickness of the second region and a thickness of the fourth region.

In the first region, in the direction of the second diameter, four layers of the first insulating member are provided, in the second region, in the direction of the second diameter, two layers of the first insulating member are provided, in the four region, in the direction of the second diameter, two layers of the second-first insulating member are provided.

The electrode assembly according to the embodiment includes a first electrode; a second electrode; and a separator between the first electrode and the second electrode, the first electrode, the second electrode, and the separator are wound such that the electrode assembly has a first diameter in a first direction and a second diameter in a second direction, with the second diameter being smaller than the first diameter, the first electrode comprises a first current collector including a first uncoated portion; and a first active material layer provided on the first current collector, the second electrode comprises a second current collector including a second uncoated portion; and a second active material layer provided on the second current collector, a first electrode tab is coupled to the first uncoated portion, a second electrode tab is coupled to the second uncoated portion, a first insulating member covering a boundary region of the first uncoated portion and the first active material layer and surrounding the first electrode tab; and a second-second insulating member surrounding the second electrode tab, the first insulating member on the first active material layer does not overlap with the first insulating member on the first uncoated portion in the direction of the second diameter.

The electrode assembly includes a first-first region, a second-first region and a third-first region are formed sequentially in the direction of the first diameter, in the first-first region, in the direction of the second diameter, two layers of the first insulating member on the first active material layer and a two layer of the first insulating member on the first uncoated portion are provided, in the second-first region, in the direction of the second diameter, two layers of the first insulating member are provided, and in the third-first region, in the direction of the second diameter, two layers of the second-second insulating member are provided.

The electrode assembly includes a fourth-second region in which two layers of the first insulating member and two layers of the second-second insulating member are provided in the direction of the second diameter.

A first-second insulating member is further disposed on the second uncoated portion, and the first-second insulating member is disposed on at least one surface of the second uncoated portion.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view of a secondary battery according to an embodiment.

FIG. 2 is a top view showing a first electrode of an electrode assembly before winding according to an embodiment.

FIG. 3 is a top view showing a second electrode of an electrode assembly before winding according to an embodiment.

FIG. 4 shows an electrode assembly after winding.

FIGS. 5 to 10 show electrode assemblies according to embodiments after winding.

FIGS. 11 to 14 show electrode assemblies according to comparative examples after winding.

FIG. 15 is a top view of a first electrode of an electrode assembly before winding according to another embodiment.

FIG. 16 is a top view of a second electrode of the electrode assembly before winding according to another embodiment.

FIGS. 17 to 20 show electrode assemblies after winding according to other embodiments.

FIGS. 21 and 22 are perspective views of a battery pack including battery modules according to some embodiments.

FIGS. 23 and 24 are a perspective view and a side view showing a vehicle including battery packs according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, an electrode assembly and a secondary battery according to an embodiment will be described with reference to the drawings. The secondary battery may be a cylindrical shape, a prismatic shape, a pouch shape, or a coin shape depending on its shape. A pouch-type secondary battery will be described below.

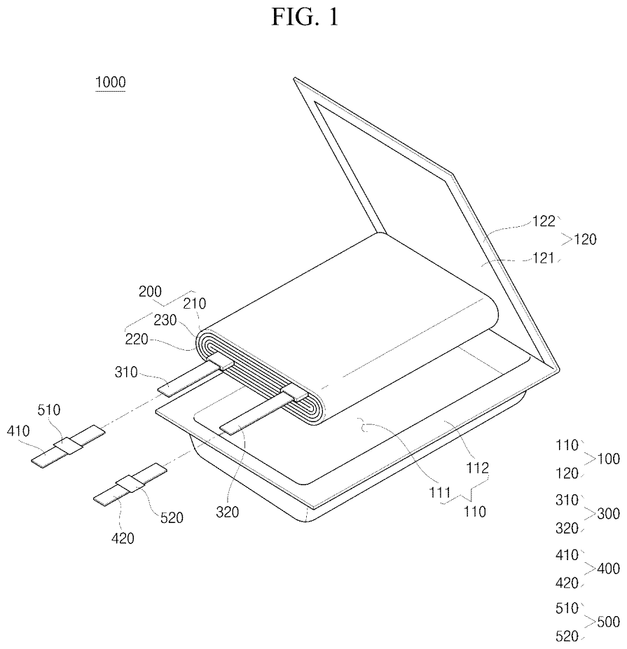

Referring to FIG. 1, a secondary battery 1000 according to an embodiment may include a case 100 and an electrode assembly 200.

The case 100 may include an accommodation part 110 and a cap part 120. The accommodation part 110 and the cap part 120 may be connected. In the embodiment depicted in FIG. 1, the case 100 is formed in a pouch shape.

The accommodation part 110 may include a concave part 111 and a first sealing part 112. The accommodation part 110 may include an accommodating space. In detail, the accommodation part 110 may include an inner bottom surface and an inner side formed by the concave part 111. The accommodating space is formed by the bottom surface and the inner side.

The first sealing part 112 may be disposed at an edge of the accommodation part 110. A sealing layer may be disposed on the first sealing part 112.

The cap part 120 may include a cover part 121 and a second sealing part 122.

The cover part 121 may cover the accommodation part 110. In particular, the cover part 121 may cover the electrode assembly 200 accommodated in the accommodation part 110.

The second sealing part 122 may be disposed at the edge of the cap part 120. The sealing layer may be disposed on the second sealing part 122. The first sealing part 112 and the second sealing part 122 may overlap each other. In detail, when the accommodation part 110 is covered by the cap part 120, the first sealing part 112 and the second sealing part 122 may face each other. With such a configuration, the accommodation part 110 and the cap part 120 may be bonded by the sealing layer.

The electrode assembly 200 may be accommodated in the case 100. In detail, the electrode assembly 200 may be accommodated in the accommodating space of the case together with the electrolyte.

In the embodiment depicted in FIG. 1, one electrode assembly is accommodated in the case. However, the present disclosure is not limited to such a configuration. In other embodiments, two or more electrode assemblies may be accommodated in the case.

The electrode assembly 200 may include a first electrode 210, a second electrode 220, and a separator 230. The electrode assembly 200 may be formed by winding the first electrode 210, the second electrode 220, and the separator 230. For example, the electrode assembly 200 may be formed by winding the first electrode 210, the second electrode 220, and the separator 230 into a jelly roll shape.

The first electrode 210 may include a first current collector and a first active material layer. The first current collector may include a metal foil such as aluminum or an aluminum alloy. The first active material layer may include a transition metal oxide. For example, the first electrode 210 may be a positive electrode.

The first electrode 210 may be connected to a first electrode tab 310. The first active material layer is not provided on the first electrode tab 310. The first electrode tab 310 may be welded to the first current collector. The first electrode tab 310 may include at least one first electrode tab.

The second electrode 220 may include a second current collector and a second active material layer. The second current collector may include a metal foil such as copper, a copper alloy, nickel, or a nickel alloy. The second active material layer may include graphite or carbon. For example, the second electrode 220 may be a negative electrode.

The second electrode 220 may be connected to a second electrode tab 320. The second active material layer is not provided on the second electrode tab 320. The second electrode tab 320 may be welded to the second current collector. The second electrode tab 320 may include at least one second electrode tab.

The separator 230 functions to prevent short circuiting between the first electrode 210 and the second electrode 220 while allowing movement of lithium ions. The separator 230 may include a polyethylene film, a polypropylene film, or a polyethylene-polypropylene film.

The first electrode tab 310 and the second electrode tab 320 may each be connected to a lead. For example, the first electrode tab 310 may be connected to a first lead 410. As such, the first electrode tab 310 may be connected to the first external terminal by the first lead 410. The second electrode tab 320 may be connected to the second lead 420, and the second electrode tab 320 may be connected to the second external terminal by the second lead 420. The first lead 410 may be formed from the same material as the first electrode tab. And the second lead 420 may be formed from the same material as the second electrode tab.

An insulating layer 500 may be disposed on a portion of the lead. For example, the insulating layer may be disposed to surround the lead. In more detail, a first insulating layer 510 may be disposed on the first lead 410, and a second insulating layer 520 may be disposed on the second lead 420. The lead 400 may be insulated from the case 100 by the insulating layer 500.

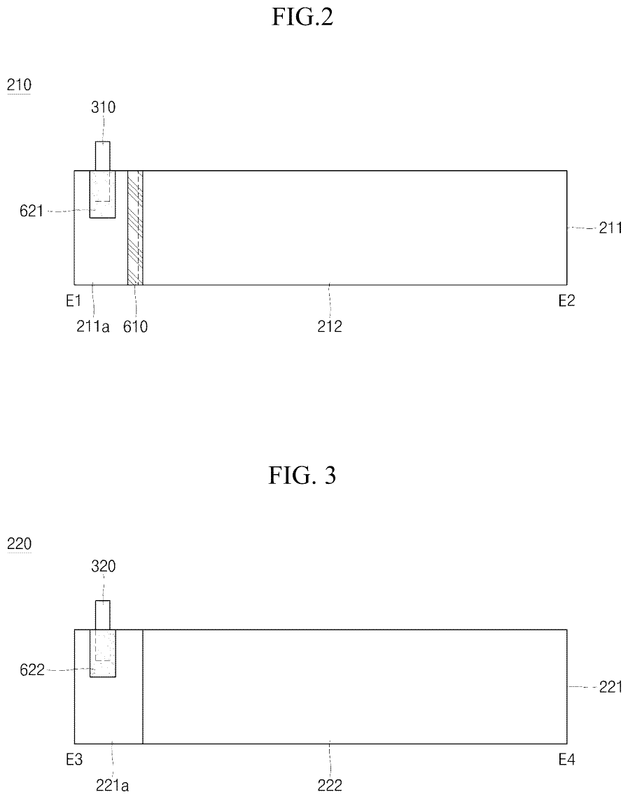

FIGS. 2 and 3 show the first electrode and the second electrode before winding.

Referring to FIG. 2, the first electrode 210 may include a first current collector 211 and a first active material layer 212. The first current collector 211 may include a first end E1 and a second end E2. The first end E1 may be an end where winding begins, and the second end E2 may be an end where winding ends when the first current collector 211 is wound.

The first active material layer 212 may be disposed on at least one of the surfaces of the first current collector. The first current collector 211 may include a first uncoated portion 211a. The first uncoated portion 211a is a region where the first active material layer 212 is not provided.

A first insulating member 610 may be disposed on a boundary region between the first uncoated portion 211a and the first active material layer 212. The first insulating member 610 may be provided on the first uncoated portion 211a and the first active material layer 212. Accordingly, the first insulating member 610 may cover the boundary region between the first uncoated portion 211a and the first active material layer 212. The first insulating member 610 may prevent a short circuit between the first electrode and the second electrode.

The first electrode tab 310 may be disposed on the first uncoated portion 211a. For example, the first electrode tab 310 may be welded and coupled to the first uncoated portion 211a.

A second-first insulating member 621 may be disposed on the first electrode tab 310. The second-first insulating member 621 may be positioned in a welding region between the first electrode tab 310 and the first uncoated portion 211a. The second-first insulating member 621 may surround the first electrode tab 310 on the first uncoated portion 211a, with the second-first insulating member 621 and the first insulating member 610 partially overlapping. The second-first insulating member 621 may serve to prevent a short circuit between the first electrode tab and the second electrode.

Referring to FIG. 3, the second electrode 220 may include a second current collector 221 and a second active material layer 222. The second current collector 221 may include a third end E3 and a fourth end E4. The third end E3 may be an end where winding begins and the fourth end E4 may be an end where winding ends when the second current collector 221 is wound.

The second active material layer 222 may be disposed on at least one of the surfaces of the second current collector. The second current collector 221 may include a second uncoated portion 221a where the second active material layer 222 is not provided.

The second electrode tab 320 may be disposed on the second uncoated portion 221a. For example, the second electrode tab 320 may be welded and coupled to the second uncoated portion 221a.

A second-second insulating member 622 may be disposed on the second electrode tab 320. The second-second insulating member 622 may be positioned in a welding region between the second electrode tab 320 and the second uncoated portion 221a. The second-second insulating member 622 may surround the second electrode tab 320 on the second uncoated portion 221a. The second-second insulating member 622 may prevent a short circuit between the second electrode tab and the first electrode.

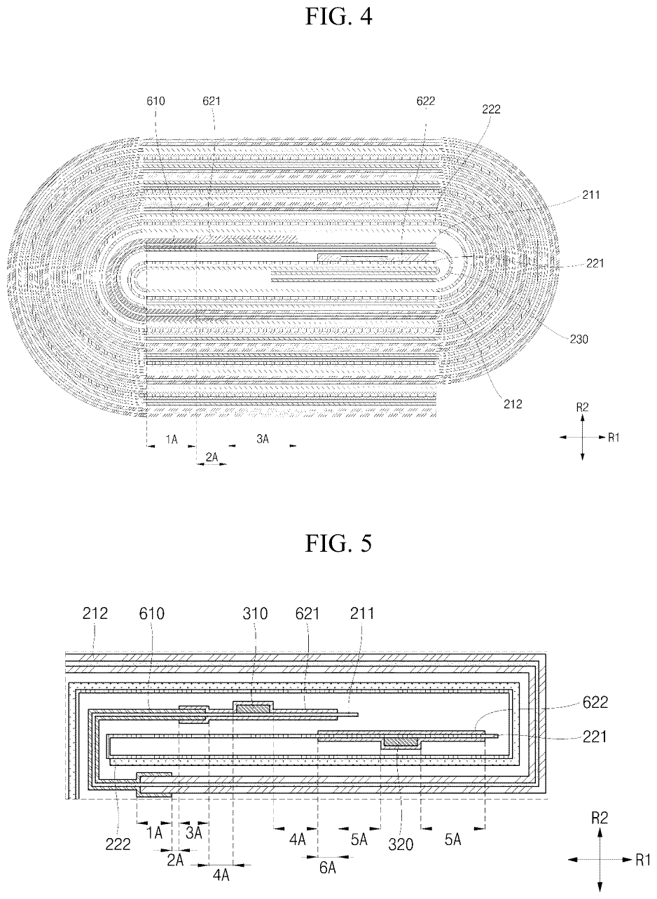

Referring to FIG. 4, the first electrode, the second electrode, and the separator 230 may be wound in one direction. For example, the first electrode 210, the second electrode 220, and two separators 230 may be wound in one direction to form a jelly roll. Then, the jelly roll may be pressed at a high temperature. The electrode assembly may thereby be formed into a shape that can be accommodated in the case. In detail, the electrode assembly 200 may have a first diameter R1 in a first direction and a second diameter R2 in a second direction, with the second diameter being smaller than the first diameter.

The first insulating member 610 and a second-first insulating member 621 may be disposed on the first uncoated portion 211a. And the second-second insulating member 622 may be disposed on the second uncoated portion 221a. As such, the electrode assembly may be thicker in the winding region of the first uncoated portion 211a and the second uncoated portion 221a.

In detail, the first electrode 210 may include the first insulating member 610 and the second-first insulating member 621. Accordingly, the electrode assembly 200 may be divided into a plurality of regions based on the first insulating member 610 and the second-first insulating member 621. For example, the electrode assembly 200 may include a first region 1A, a second region 2A, and a third region 3A in the direction of the first diameter R1. The first insulating member 610 may be disposed in the first region 1A. In detail, the first insulating member 610 may overlap in the direction of the second diameter in the first region 1A. That is, the overlapping first insulating members 610 may be disposed at opposite positions with respect to the second diameter direction.

The first insulating member 610 and the second-first insulating member 621 may be disposed in the second region 2A, with the first insulating member 610 disposed on the first active material layer 212. In detail, the first insulating member 610 and the second-first insulating member 621 may overlap in the direction of the second diameter in the second region 2A.

The second-first insulating member 621 may also be disposed in the third region 3A. That is, the second-first insulating member 621 may be disposed in the direction of the second diameter in the third region 3A.

Accordingly, the thicknesses of the first region 1A, the second region 2A, and the third region 3A may be different. That is, the thickness of the second region 2A may be greater than the thicknesses of the first region 1A and the third region 3A. Therefore, when the electrode assembly is pressed, the compressed size of each region may be different. In particular, when regions with large thickness deviations are adjacent to each other, the difference in the compressed size of each region may become larger.

In detail, since the second region 2A has a large thickness, the adhesion between the electrode and the separator overlapping in the direction of the first diameter in the second region may become large. On the other hand, since the first region 1A and the third region 3A have small thicknesses, the adhesion between the electrode and the separator overlapping in the direction of the first diameter in the first region and the third region may become small. Accordingly, the adhesion of some regions in the secondary battery is reduced. As a result, the resistance may gradually increase in a local region of the secondary battery during charging and discharging of the secondary battery, and a side region may be formed in a local region of the secondary battery. This may cause the performance and lifespan of the secondary battery to be reduced.

An embodiment of the present disclosure controls the positions of the first insulating member, the second-first insulating member and the second-second insulating member. As a result, the above-described problem related to different thicknesses in the electrode assembly may be solved.

Hereinafter, electrode assemblies according to embodiments will be described with reference to FIGS. 5 to 10. FIGS. 5 to 10 are drawings illustrating the winding of a portion of an area adjacent to an end where winding of the electrode assembly begins. For convenience, the separator is omitted in these drawings.

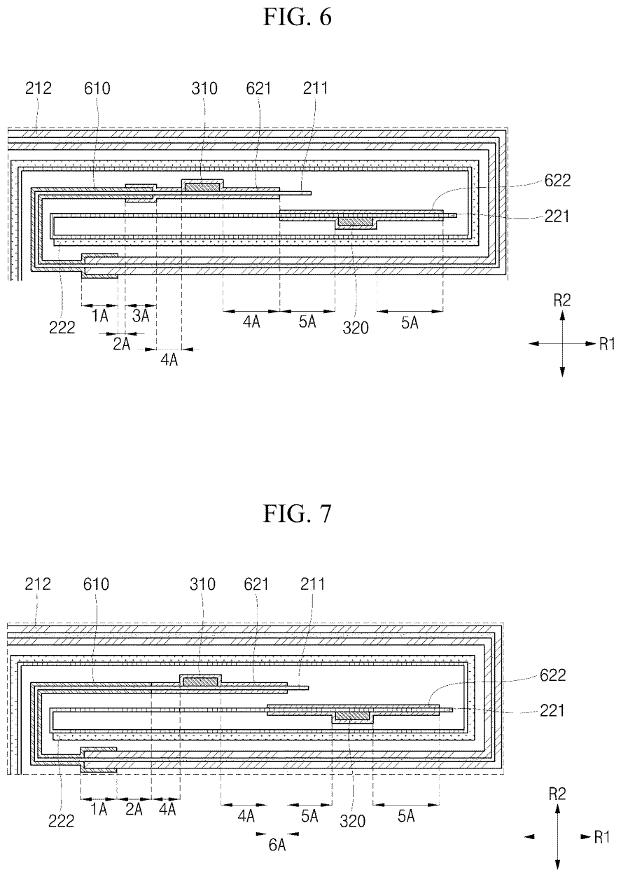

Referring to FIGS. 5 and 6, in the direction of the first diameter, the electrode assembly may include a first region 1A, a second region 2A, a third region 3A, and a fourth region 4A. The first region 1A, the second region 2A, the third region 3A, and the fourth region 4A may be sequentially disposed in the direction of the first diameter.

The first insulating member 610 is disposed in the first region 1A, and the first insulating member 610 is disposed on the first active material layer 212. As such, in the first region 1A, the first electrode 210, the second electrode 220, and four layers of the first insulating member 610 are disposed in the direction of the second diameter.

The first insulating member 610 is also disposed in the second region 2A. But the first insulating member 610 is not disposed on the first active material layer 212 of the second region 2A. That is, in the second region 2A, the first electrode 210, the second electrode 220, and two layers of the first insulating member 610 are disposed in the direction of the second diameter.

In the third region 3A, the first insulating member 610 and a second-first insulating member 621 are disposed, and the second-first insulating member 621 is disposed on the first insulating member 610. That is, in the third region 3A, the first electrode 210, the second electrode 220, two layers of the first insulating member 610, and two layers of the second-layer insulating member 621 are disposed in the direction of the second diameter.

The fourth region 4A is a region adjacent to the first electrode tab 310. In the fourth region 4A, the second-first insulating member 621 is disposed on the uncoated portion of the first current collector. That is, in the fourth region 4A, the first electrode 210, the second electrode 220, and two layers of the second-layer insulating member 621 are disposed in the direction of the second diameter R2.

Therefore, the first insulating member on the first active material layer does not overlap with the second-first insulating member in the direction of the second diameter. That is, the first insulating member on the first active material layer of the first region 1A does not overlap with the first insulating member and the second-first insulating member of the third region 3A in the direction of the second diameter. Accordingly, the thickness of the electrode assembly may be uniform.

In detail, the thicknesses of the first region 1A and the third region 3A may be similar, and the thicknesses of the second region 2A and the fourth region 4A may be similar. Further, the thickness of the first region 1A and the third region 3A may be greater than the thickness of the second region 2A and the fourth region 4A. And, the difference between the thickness of the first region 1A and the third region 3A and the thickness of the second region 2A and the fourth region 4A may be less than or equal to twice the thickness of the first insulating member. Or the difference between the thickness of the first region 1A and the third region 3A and the thickness of the second region 2A and the fourth region 4A may be less than or equal to twice the thickness of the second-first insulating member.

Therefore, the thicknesses of the first region to fourth regions adjacent to the first electrode tab 310 may be uniform. Accordingly, when forming the electrode assembly, the difference in the compressed size of the regions may be reduced. Accordingly, the adhesion between the electrode and the separator may be made uniform in multiple regions. As a result, the lifespan and performance of the electrode assembly may be improved.

The second-first insulating member 621 and the second-second insulating member 622 may overlap in the direction of the second diameter. Or, in other embodiments, the second-first insulating member 621 and the second-second insulating member 622 may not overlap in the direction of the second diameter.

Referring to FIG. 5, the second-first insulating member 621 and the second-second insulating member 622 may overlap in the direction of the second diameter. In this configuration, the electrode assembly 200 may include a fifth region 5A and a sixth region 6A. The second-second insulating member 622 is disposed in the fifth region 5A, and the fifth region 5A is a region adjacent to the second electrode tab 320. That is, in the fifth region 5A, the first electrode 210, the second electrode 220, and two layers of the second-second insulating member 622 are disposed in the direction of the second diameter.

The sixth region 6A is disposed with the second-first insulating member 621 and the second-second insulating member 622. That is, in the sixth region 6A, the first electrode 210, the second electrode 220, two layers of the second-first insulating member 621, and two layers of the second-second insulating member 622 are disposed in the direction of the second diameter.

Thus, the thickness of the fifth region 5A may be similar to the thicknesses of the second region 2A and the fourth region 4A. And the thickness of the sixth region 6A may be similar to the thicknesses of the first region 1A and the third region 3A.

Referring to FIG. 6, in another embodiment the second-first insulating member 621 and the second-second insulating member 622 may not overlap in the direction of the second diameter. Accordingly, the electrode assembly 200 may include the fifth region 5A but not include the sixth region 6A.

The fifth region 5A is a region adjacent to the second electrode tab 320, and the second-second insulating member 622 is disposed in the fifth region 5A. That is, in the fifth region, the first electrode 210, the second electrode 220, and two layers of the second-second insulating member 622 are disposed in the second diameter direction. Thus, the thickness of the fifth region 5A may be similar to the thicknesses of the second region 2A and the fourth region 4A.

In the electrode assembly according to embodiments, the positions of the first insulating member, the second-first insulating member, and the second-second insulating member are controlled. Accordingly, thickness differences in the second diameter direction may be reduced. Therefore, the electrode assembly may be compressed while maintaining a uniform adhesion throughout. Therefore, the performance and lifespan of the secondary battery including the electrode assembly may be improved.

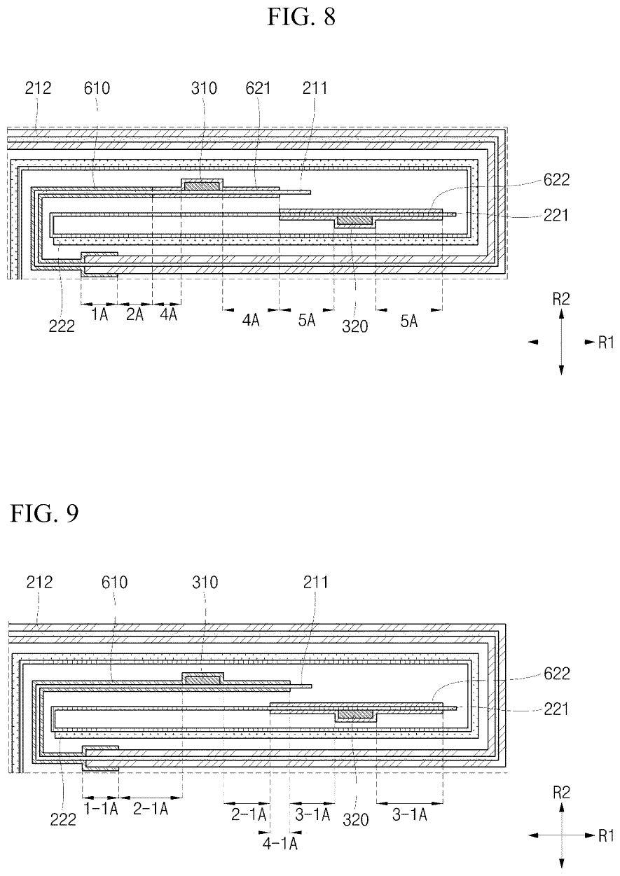

FIGS. 7 and 8 show an electrode assembly after winding according to another embodiment.

Referring to FIGS. 7 and 8, the electrode assembly may not include the third region 3A. That is, the second-first insulating member 621 may be disposed only on the uncoated portion of the first current collector and not disposed on the first insulating member 610.

Accordingly, the thickness of the electrode assembly may be uniform. In detail, the thicknesses of the regions except for the first region 1A and the sixth region 6A may be similar. Accordingly, the thickness in the second diameter direction may be more uniform through the regions in the first diameter direction. And the electrode assembly may be compressed while having a uniform adhesion throughout the electrode assembly. Accordingly, the performance and lifespan of the secondary battery including the electrode assembly may be improved.

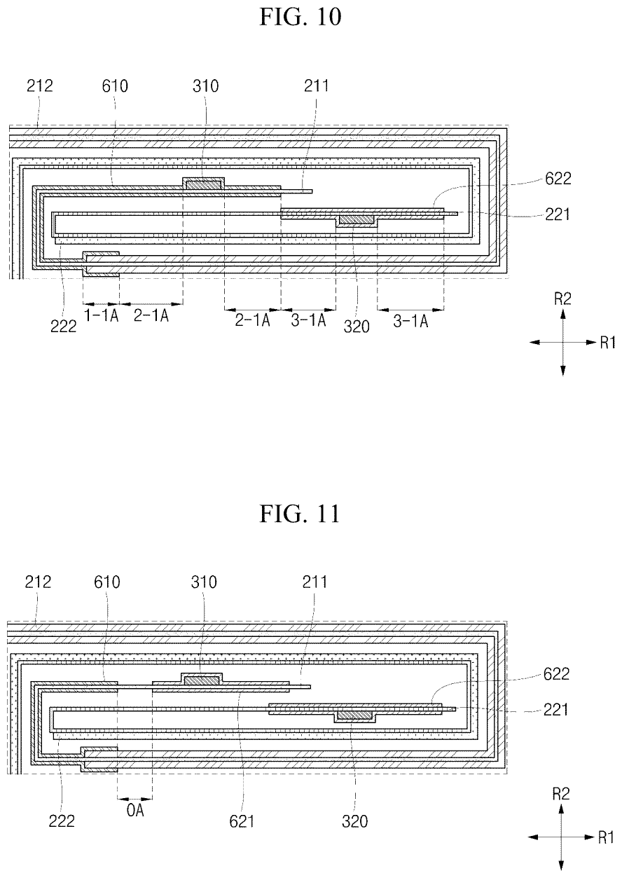

FIGS. 9 and 10 show an electrode assembly after winding according to another embodiment.

Referring to FIGS. 9 and 10, the electrode assembly 200 may include the first insulating member 610 and the second-second insulating member 622. The first insulating member 610 and the second-first insulating member 621 may be formed integrally.

Referring to FIG. 9, the electrode assembly 200 may include a first-first region 1-1A, a second-first region 2-1A, a third-first region 3-1A, and a fourth-first region 4-1A in the direction of the first diameter. The first-first region 1-1A, the second-first region 2-1A, the fourth-first region 4-1A, and the third-first region 3-1A may be sequentially disposed in the direction of the first diameter.

The first insulating member 610 is disposed on the first active material layer 212 in the first-first region 1-1A. In detail, in the first-first region 1-1A, the first electrode 210, the second electrode 220, and two layers of the first insulating member 610 are disposed in the direction of the second diameter.

The first insulating member 610 is also disposed in the second-first region 2-1A, but the first insulating member 610 is not disposed on the first active material layer 212 of the second-first region 2-1A. As such, in the second-first region 2-1A, the first electrode 210, the second electrode 220, and two layers of the first insulating member 610 are disposed in the direction of the second diameter.

The second-second insulating member 622 is disposed in the third-first region 3-1A, which is adjacent to the second electrode tab 320. That is, in the third-first region 3-1A, the first electrode (210), the second electrode (220), and two layers of the second-second insulating member 622 are formed in the direction of the second diameter.

The first insulating member 610 and the second-second insulating member 622 are disposed in the fourth-first region 4-1A. That is, in the fourth-first region 4-1A, the first electrode 210, the second electrode 220, two layers of the first insulating member 610, and two layers of the second-second insulating member 622 are disposed in the direction of the second diameter.

Thus, the first insulating member on the first active material layer does not overlap with the first insulating member in another region. In detail, the first insulating member on the first active material layer does not overlap with the first insulating member on the first uncoated portion in the direction of the second diameter. That is, the first insulating member on the first active material layer in the first-fist region 1-1A does not overlap with the first insulating member of the second-first region 2-1A in the direction of the second diameter. Accordingly, the thickness of the electrode assembly may be more uniform.

Further, the thicknesses of the first-first region and the fourth-first region may be similar. And the thicknesses of the second-first region and the third-first region may be similar. Also, the thicknesses of the first-first region and the fourth-first region may be greater than the thicknesses of the second-first region and the third-first region.

The thicknesses of the first-first region to the fourth-first region adjacent to the first electrode tab 310 may be uniform. Accordingly, when forming the electrode assembly, differences in the compressed sizes of regions may be reduced. As a result, the adhesion between the electrode and the separator in each region may be uniform. And, thus, the lifespan of the electrode assembly may be maintained because there is not an increase in resistance, which may result from nonuniformity. Also, one insulating member is disposed on the first uncoated portion and the first electrode tab. Accordingly, the process efficiency of the electrode assembly may be improved.

Referring to FIG. 10, in another embodiment, the first insulating member 610 and the second-second insulating member 622 may not overlap in the direction of the second diameter. Accordingly, the electrode assembly 200 may not include the fourth-first region 4-1A. Thus, the thickness of the electrode assembly may be more uniform.

In detail, the thicknesses of the regions excluding the first-first region 1-1A may be similar. Accordingly, the thickness in the second diameter direction in the regions in the first diameter direction may be more uniform. As a result, the electrode assembly may be compressed while maintaining a uniform adhesion. Thus, the lifespan of the secondary battery including the electrode assembly may be improved.

FIGS. 11 to 14 show the electrode assembly after winding according to comparative examples.

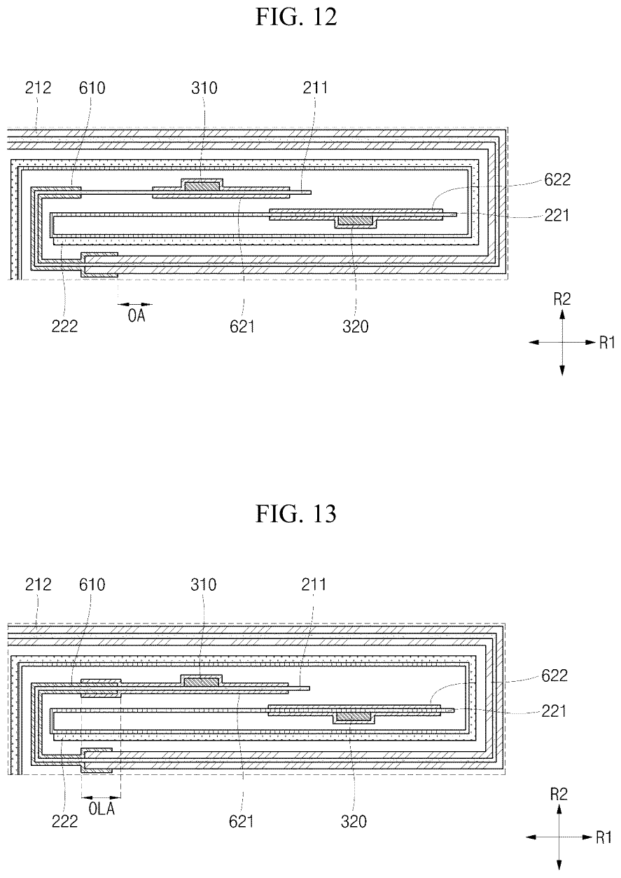

Referring to FIGS. 11 and 12, the first insulating member 610 and the second-first insulating member 621 do not overlap in the direction of the second diameter R2. But, in this configuration, the first insulating member 610 and the second-first insulating member 621 are spaced apart in the direction of the first diameter R1 such that an open region OA is formed. The insulating member is not disposed in the open region OA. Accordingly, the thickness of the open region OA is smaller than the thicknesses of other regions. And the adhesion between the electrode and the separator in the open region may decrease. Accordingly, the performance of the electrode assembly may be reduced because of the open region, and the lifespan of the electrode assembly may be reduced.

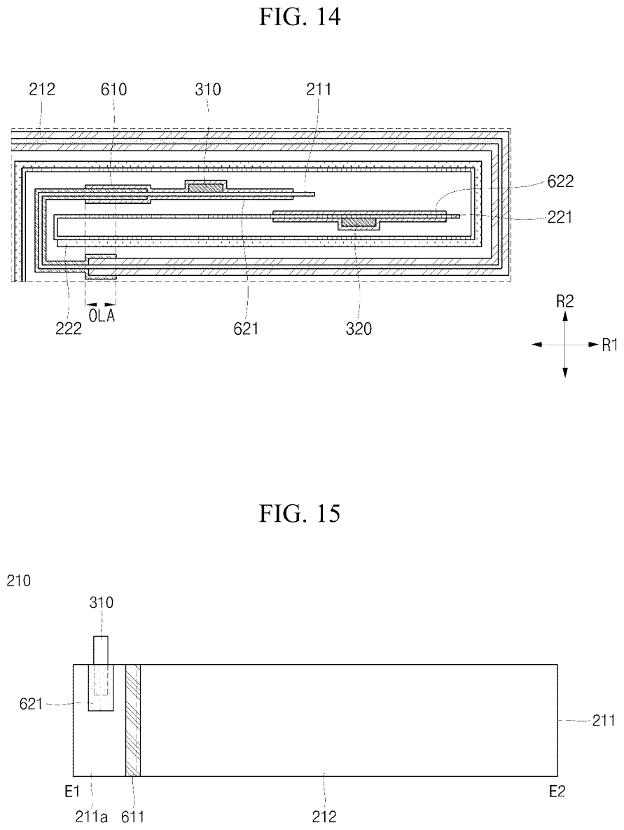

Referring to FIGS. 13 and 14, the first insulating member 610 and the second-first insulating member 621 overlap in the direction of the second diameter R2. In detail, four layers of the first insulating member 610 and two layers of the second-first insulating member 621 overlap in the direction of the second diameter R2. Accordingly, an overlapping region OLA is formed in the electrode assembly. And the thickness of the overlapping region OLA may be greater than the thicknesses of other regions. As such, adhesion between the electrode and the separator overlapping in the direction of the second diameter R2 in a region other than the overlapping area may be less. As a result, the performance of the electrode assembly may decrease because of the overlapping region, and the lifespan of the electrode assembly may decrease.

Hereinafter, the electrode assembly according to further embodiments will be described with reference to FIGS. 15 to 20. Features of the further embodiments that are the same as in the embodiments described above will be omitted.

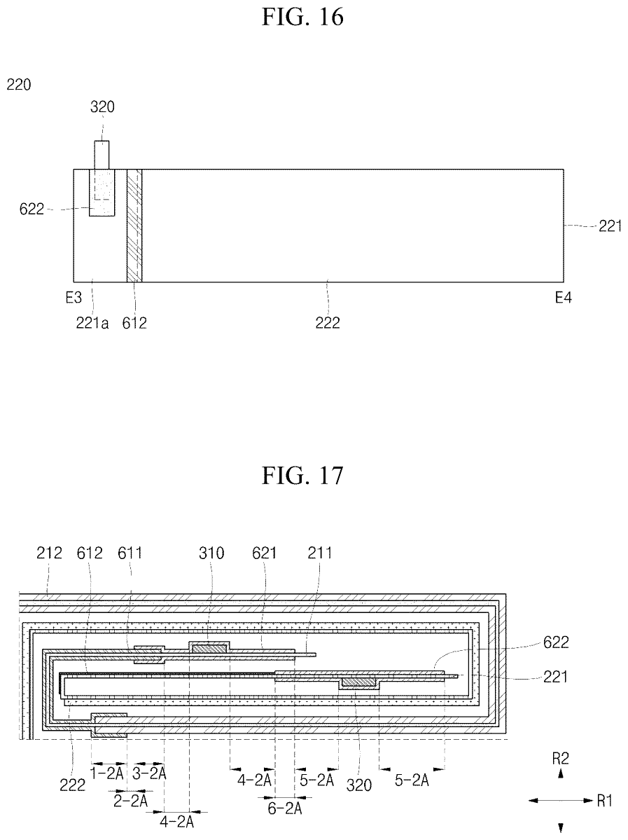

Referring to FIGS. 15 and 16, the second electrode 220 may also include the first insulating member. In detail, the first electrode 210 may include a first-first insulating member 611, and the second electrode 220 may include a first-second insulating member 612. The first-second insulating member 612 may be disposed on the second uncoated portion 221a, or the first-second insulating member 612 may be disposed on the second active material layer 222 while covering the boundary region between the second uncoated portion 221a and the second active material layer 222. The first-second insulating member 612 may be disposed on at least one of the surfaces of the second uncoated portion 221a. The first-second insulating member 612 may supplement the first-first insulating member 611, as the first-second insulating member 612 may prevent a short circuit between the first electrode and the second electrode.

Referring to FIG. 17, in the direction of the first diameter, the electrode assembly may include a first-second region 1-2A, a second-second region 2-2A, a third-second region 3-2A, and a fourth-second region 4-2A. That is, the first-second region 1-2A, the second-second region 2-2A, the third-second region 3-2A, and the fourth-second region 4-2A may be sequentially disposed in the direction of the first diameter R1.

The first-first insulating member 611 and a first-second insulating member 612 are disposed in the first-second region 1-2A, with the first-first insulating member 611 being disposed on the first active material layer 212. In detail, in the first-second region 1-2A, the first electrode 210, the second electrode 220, four layers of the first-first insulating member 611 and one or two layers of the first-second insulating member 612 are disposed in the direction of the second diameter.

The first-first insulating member 611 and the first-second insulating member 612 are disposed in the second-second region 2-2A, but the first-first insulating member 611 is not disposed on the first active material layer 212 of the second-second region 2-2A. That is, in the second-second region 2-2A, the first electrode 210, the second electrode 220, two layers of the first-first insulating member 611, and one or two layers of the first-second insulating member 612 are disposed in the direction of the second diameter.

In the third-second region 3-2A, the first-first insulating member 611, the first-second insulating member 612, and the second-first insulating member 621 are disposed. The second-first insulating member 621 is disposed on the first-first insulating member 611. Thus, in the third-second region 3-2A, the first electrode 210, the second electrode 220, two layers of the first-first insulating member 611, one or two layers of the first-second insulating member 612, and two layers of the second-first insulating member 621 are disposed in the direction of the second diameter.

The fourth-second region 4-2A is adjacent to the first electrode tab 310. In the fourth-second region 4-2A, the first-second insulating member 612 and the second-first insulating member 621 are disposed. The second-first insulating member 621 is disposed on the uncoated portion of the first current collector. That is, in the fourth-second region 4-2A, the first electrode 210, the second electrode 220, the one or two layers first-second insulating member 612 and the two layers of the second-first insulating member 621 are disposed in the direction of the second diameter.

With the configuration in this embodiment, the thicknesses of the first-second region 1-2A and the third-second region 3-2A may be similar. And the thicknesses of the second-second region 2-2A and the fourth-second region 4-2A may be similar. The thicknesses of the first-second region 1-2A and the third-second region 3-2A may be greater than the thicknesses of the second-second region 2-2A and the fourth-second region 4-2A. The difference between the thickness of the first-second region 1-2A and the third-second region 3-2A and the thickness of the second-second region 2-2A and the fourth-second region 4-2A may be less than or equal to twice the thickness of the first-first insulating member. Or the difference between the thickness of the first-second region 1-2A and the third-second region 3-2A and the thickness of the second-second region 2-2A and the fourth-second region 4-2A may be less than or equal to twice the thickness of the second-first insulating member.

Therefore, the thickness of the first-second to the fourth-second regions adjacent to the first electrode tab 310 may be uniform. Accordingly, when forming the electrode assembly, the difference in the compressed size of each region may be reduced. Therefore, the adhesion between the electrode and the separator in each region may be uniform. And the performance and lifespan of the electrode assembly may be improved.

The second-first insulating member 621 and the second-second insulating member 622 may overlap in the direction of the second diameter R2. Or the second-first insulating member 621 and the second-second insulating member 622 may not overlap in the direction of the second diameter R2.

Referring to FIG. 17, the second-first insulating member 621 and the second-second insulating member 622 may overlap in the direction of the second diameter. With this configuration, the electrode assembly 200 may include a fifth-second region 5-2A and a sixth-second region 6-2A.

The above fifth-second region 5-2A and the sixth-second region 6-2A may be the same as the fifth region 5A and the sixth region 6A of FIG. 5 described above. Therefore, further description is omitted.

Therefore, the thickness of the fifth-second region 5-2A may be similar to the thicknesses of the second-second region 2-2A and the fourth-second region 4-2A. And the thickness of the sixth-second region 6-2A may be similar to the thicknesses of the first-second region 1-2A and the third-second region 3-2A.

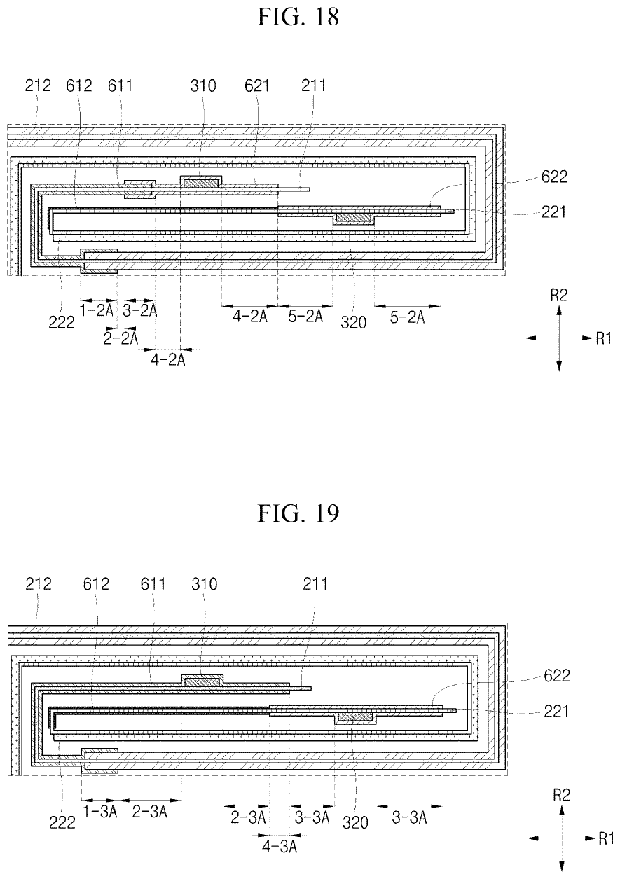

Referring to FIG. 18, the second-first insulating member 621 and the second-second insulating member 622 may not overlap in the direction of the second diameter R2. Accordingly, while the electrode assembly 200 may include the fifth-second region 5-2A, the electrode assembly 200 may not include the sixth-second region 6-2A.

The fifth-second region 5-2A may be the same as the fifth region 5A of FIG. 6 described above. Therefore, a further description of this region is omitted.

Accordingly, the thickness of the fifth-second region 5-2A may be similar to the thicknesses of the second-second region 2-2A and the fourth-second region 4-2A.

The electrode assembly according to another embodiment includes the first-first insulating member and the first-second insulating member. Accordingly, the electrode assembly may be made safer. And, the positions of the first-first insulating member, the first-second insulating member, the second-first insulating member, and the second-second insulating member are controlled. Accordingly, thickness differences in the second diameter direction may be reduced in the regions in the first diameter direction. Accordingly, the electrode assembly may be compressed while maintaining a uniform adhesion throughout the electrode assembly. Accordingly, the performance and lifespan of the secondary battery including the electrode assembly may be improved.

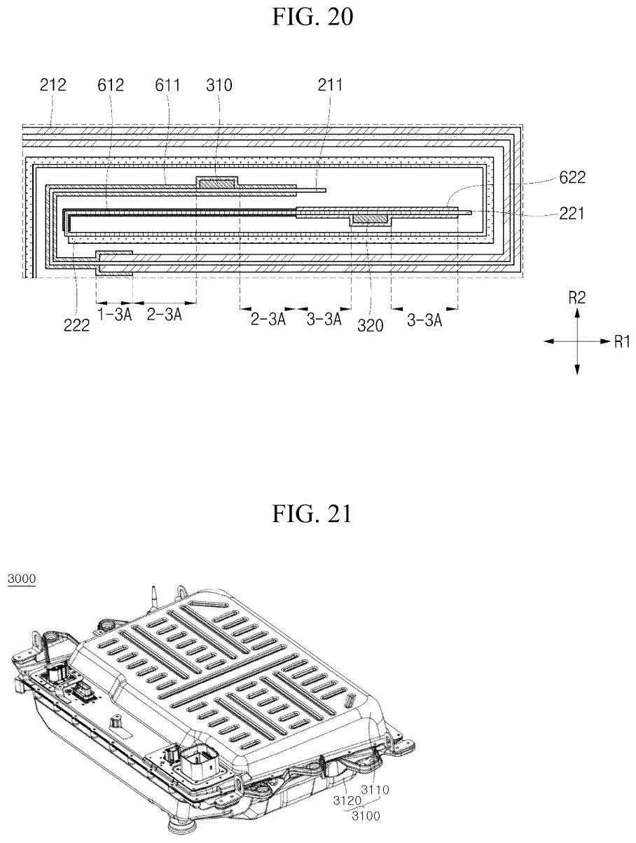

Referring to FIGS. 19 and 20, the electrode assembly 200 may include the first-first insulating member 611, the first-second insulating member 612, and the second-second insulating member 622. That is, the first-first insulating member 611 and the second-first insulating member 621 may be formed integrally.

Referring to FIG. 19, the electrode assembly 200 may include a first-third region 1-3A, a second-third region 2-3A, a third-third region 3-3A, and a fourth-third region 4-3A in the direction of the first diameter. The first-third region 1-3A, the second-third region 2-3A, the fourth-third region 4-3A, and the third-third region 3-3A may be sequentially disposed in the direction of the first diameter.

In the first-third region 1-3A, the first-first insulating member 611 and the first-second insulating member 612 are disposed, with the first-first insulating member 611 being disposed on the first active material layer 212. In detail, in the first-third region 1-3A, the first electrode 210, the second electrode 220, four layers of the first-first insulating member 611, and one or two layers of the first-second insulating member 612 are disposed in the direction of the second diameter.

The first-first insulating member 611 and the first-second insulating member 612 are disposed in the second-third region 2-3A. But the first-first insulating member 611 is not disposed on the first active material layer 212 of the second-third region 2-3A. That is, in the second-third region 2-3A, the first electrode 210, the second electrode 220, two layers of the first-first insulating member 611, and two layers of the first-second insulating member 612 are disposed in the direction of the second diameter.

In the third-third region 3-3A, the second-second insulating member 622 is disposed. The third-third region 3-3A is a region adjacent to the second electrode tab 320. That is, in the third-third region 3-3A, the first electrode 210, the second electrode 220, and two layers of the second-second insulating member 622 are disposed in the direction of the second diameter.

In the fourth-third region 4-3A, the first-first insulating member 611 and the second-second insulating member 622 are disposed. That is, in the fourth-third region 4-3A, the first electrode 210, the second electrode 220, two layers of the first-first insulating member 611, and two layers of the second-second insulating member 622 are disposed in the direction of the second diameter.

Thus, the thicknesses of the first-third region and the fourth-third region may be similar. And the thicknesses of the second-third region and the third-third region may be similar. Further, the thickness of the first-third region and the fourth-third region may be greater than the thickness of the second-third region and the third-third region.

With this configuration, the thickness of the first-third region to the fourth-third region adjacent to the first electrode tab 310 may be uniform. Accordingly, when the electrode assembly is formed, differences in the compressed sizes of the regions may be reduced. As a result, the adhesion between the electrode and the separator may be uniform in each region, and the performance and lifespan of the electrode assembly may be improved. Still further, one insulating member is disposed on the first uncoated portion and the first electrode tab. Accordingly, the process efficiency of the electrode assembly may be improved.

Referring to FIG. 20, the first-first insulating member 611 and the second-second insulating member 622 may not overlap in the direction of the second diameter. Accordingly, the electrode assembly 200 may not include the fourth-third region 4-3A. As such, the thickness of the electrode assembly may become more uniform. In detail, the thicknesses of regions excluding the first-third region 1-3A may be similar. Accordingly, the thickness in the second diameter direction in the regions in the first diameter direction may become more uniform. Thus, when the electrode assembly is compressed, uniform adhesion may be maintained throughout the electrode assembly. And the performance and lifespan of the secondary battery including the electrode assembly may be improved.

The electrode assembly according to embodiments of the present disclosure is formed by being wound in one direction. Subsequently, the electrode assembly is pressed to a final shape.

The positions of the insulating members of the electrode assembly are controlled. In detail, the insulating member includes the first insulating member disposed on the uncoated portions of the first electrode and the second electrode, and the second insulating member is disposed on the first electrode tab and the second electrode tab. The first insulating member and the second insulating member each have a set thickness. And the first insulating member and the second insulating member are disposed at set positions.

After an electrode assembly is wound, the thickness of the electrode assembly might vary from region to region by the first insulating member and the second insulating member. When the same pressure is applied to the electrode assembly, the compressed size of each region may vary. More specifically, the compressed size may be reduced in a region with a small thickness. As a result, the adhesion of the first electrode, the second electrode, and the separator in the region with a small thickness may be reduced. As the charging and discharging of the secondary battery proceeds, the resistance of the region with a small adhesion may gradually increase. Accordingly, over time, lithium ions may not move between the first electrode and the second electrode in a region where the adhesion is low. Accordingly, the performance and lifespan of the secondary battery may decrease.

But in embodiments of the present disclosure that include the first insulating member and the second insulating member disposed at set positions, the thickness of the electrode assembly may become uniform. Accordingly, side reactions in regions of the electrode assembly may be prevented. Accordingly, the secondary battery according to the embodiment may have improved lifespan and performance.

The secondary battery of the present disclosure may be used in portable small electronic devices such as smartphones, feature phones, notebook computers, digital cameras, and camcorders. In other cases, a battery module and a battery pack including a plurality of secondary batteries according to the present disclosure may be used as a power source for driving a motor of a hybrid vehicle or an electric vehicle and as a battery for storing power.

The secondary battery described above may form a battery module. For example, the battery module may include a plurality of secondary batteries. The plurality of secondary batteries may be connected to each other in series, parallel, or series/parallel by a bus bar.

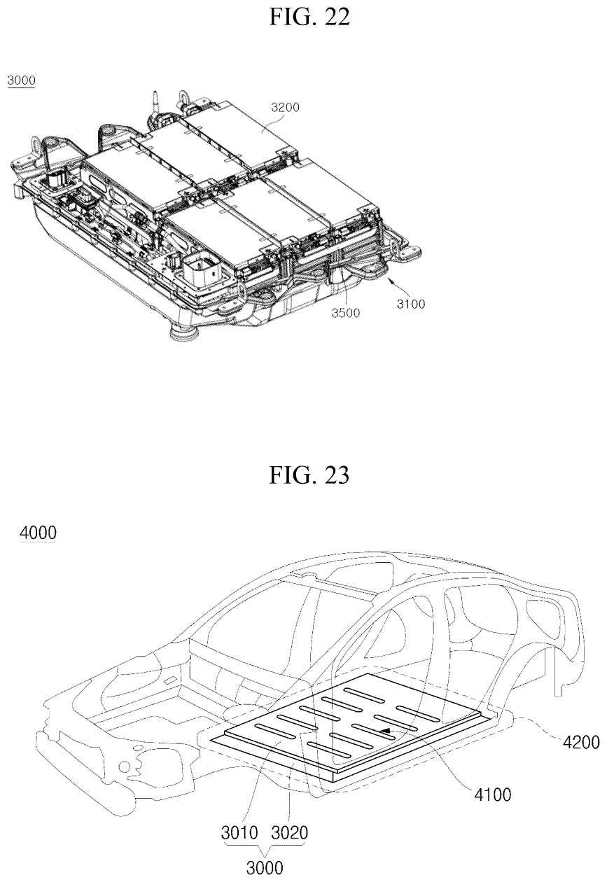

FIGS. 21 and 22 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 23, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

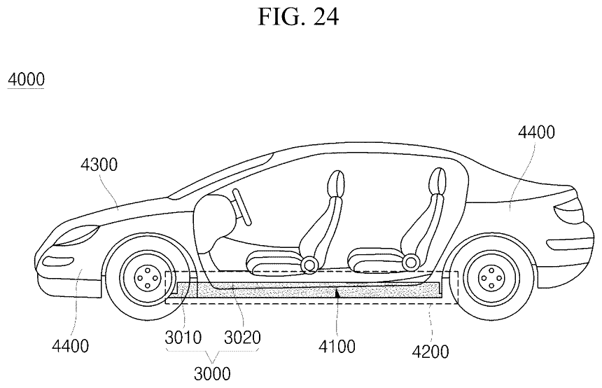

In FIG. 24, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. An electrode assembly comprising:
a first electrode;
a second electrode; and
a separator between the first electrode and the second electrode,
wherein the first electrode, the second electrode, and the separator are wound such that the electrode assembly has a first diameter in a first direction and a second diameter in a second direction, with the second diameter being smaller than the first diameter,
wherein the first electrode comprises a first current collector including a first uncoated portion, and a first active material layer is provided on the first current collector,
wherein the second electrode comprises a second current collector including a second uncoated portion, and a second active material layer is provided on the second current collector,
wherein a first electrode tab is coupled to the first uncoated portion,
wherein a second electrode tab is coupled to the second uncoated portion,
wherein a first insulating member covers a boundary region between the first uncoated portion and the first active material layer,
wherein a second-first insulating member surrounds the first electrode tab,
wherein a second-second insulating member surrounds the second electrode tab, and
wherein the first insulating member on the first active material layer does not overlap with the second-first insulating member in the direction of the second diameter.

2. The electrode assembly as claimed in claim 1, wherein the electrode assembly includes a first region, a second region, a third region and a fourth region in the direction of the first diameter, and
wherein a thickness of the first region and a thickness of the third region are greater than a thickness of the second region and a thickness of the fourth region.

3. The electrode assembly as claimed in claim 2, wherein a difference between the thicknesses of the first region and the third region and the thicknesses of the second region and the fourth region is less than or equal to twice the thickness of the first insulating member.

4. The electrode assembly as claimed in claim 2, wherein a difference between the thicknesses of the first region and the third region and the thicknesses of the second region and the fourth region is less than or equal to twice the thickness of the second-first insulating member.

5. The electrode assembly as claimed in claim 2, wherein in the first region, in the direction of the second diameter, two layers of the first insulating member are provided on the first active material layer and two layers of the first insulating member are provided on the first uncoated portion,
wherein, in the second region, in the direction of the second diameter, two layers of the first insulating member are provided,
wherein, in the third region, in the direction of the second diameter, two layers of the first insulating member and two layers of the second-first insulating member are provided, and
wherein in the fourth region, in the direction of the second diameter, two layers of the second-first insulating member is provided.

6. The electrode assembly as claimed in claim 2, wherein the electrode assembly includes a fifth region in which two layers of second-second insulating members are provided in the direction of the second diameter.

7. The electrode assembly as claimed in claim 6, wherein the electrode assembly includes a sixth region in which two layers of second-first insulating members and two layers of the second-second insulating member are provided in the direction of the second diameter.

8. The electrode assembly as claimed in claim 1, wherein a first-second insulating member covers a boundary region between the second uncoated portion and the second active material layer.

9. The electrode assembly as claimed in claim 8, wherein the electrode assembly includes a first-second region, a second-second region, a third-second region and a fourth-second region in the direction of the first diameter, and
wherein a thickness of the first-second region and a thickness of the third-second region are greater than a thickness of the second-second region and a thickness fourth-second region.

10. The electrode assembly as claimed in claim 9, wherein a difference between the thicknesses of the first-second region and the third-second region and the thicknesses of the second-second region and the fourth-second region is less than or equal to twice the thickness of the first-first insulating member.

11. The electrode assembly as claimed in claim 9, wherein a difference between the thicknesses of the first-second region and the third-second region and the thicknesses of the second-second region and the fourth-second region is less than or equal to twice the thickness of the second-first insulating member.

12. The electrode assembly as claimed in claim 9, wherein, in the first-second region, in the direction of the second diameter, two layers of the first-first insulating member on the first active material layer, two layers of the first-first insulating member on the first uncoated portion, and one or two layers of the first-second insulating member are provided,
wherein, in the second-second region, in the direction of the second diameter, two layers of the first-first insulating member and one or two layers of the first-second insulating member are provided,
wherein in the third-second region, in the direction of the second diameter, two layers of the first-first insulating member, one or two layers of the first-second insulating member, and two layers of the second-first insulating member are provided, and
wherein, in the fourth-second region, in the direction of the second diameter, one or two layers of the first-second insulating member and two layers of the second-first insulating member are provided.

13. The electrode assembly as claimed in claim 12, wherein the electrode assembly includes a fifth-second region in which two layers of second-second insulating members are provided in the direction of the second diameter.

14. The electrode assembly as claimed in claim 13, wherein the electrode assembly includes a sixth-second region in which two layers of the second-first insulating member and two layers of the second-second insulating member are provided in the direction of the second diameter.

15. The electrode assembly as claimed in claim 1, wherein the electrode assembly includes a first region, a second region, and a fourth region in the direction of the first diameter, and
wherein a thickness of the first region is greater than a thickness of the second region and a thickness of the fourth region.

16. The electrode assembly as claimed in claim 15, wherein, in the first region, in the direction of the second diameter four layers of the first insulating member are provided,
wherein, in the second region, in the direction of the second diameter, two layers of the first insulating member are provided,
wherein, in the four region, in the direction of the second diameter, two layers of the second-first insulating member are disposed.

17. An electrode assembly comprising:
a first electrode;
a second electrode; and
a separator between the first electrode and the second electrode,
wherein the first electrode, the second electrode, and the separator are wound such that the electrode assembly has a first diameter in a first direction and a second diameter in a second direction, with the second direction being smaller than the first diameter,
wherein the first electrode comprises a first current collector including a first uncoated portion, and a first active material layer is provided on the first current collector,
wherein the second electrode comprises a second current collector including a second uncoated portion, and a second active material layer is provided on the second current collector,
wherein a first electrode tab is coupled to the first uncoated portion,
wherein a second electrode tab is coupled to the second uncoated portion,
wherein a first insulating member covers a boundary region of the first uncoated portion and the first active material layer and surroundings the first electrode tab, and a second-second insulating member surrounds the second electrode tab,
wherein the first insulating member on the first active material layer does not overlap with the first insulating member on the first uncoated portion in the direction of the second diameter.

18. The electrode assembly as claimed in claim 17, wherein the electrode assembly includes a first-first region, a second-first region, and a third-first region in the direction of the first diameter,
wherein, in the first-first region, in the direction of the second diameter, two layers of the first insulating member on the first active material layer and a two layer of the first insulating member on the first uncoated portion are provided,
wherein, in the second-first region, in the direction of the second diameter, two layers of the first insulating member are provided, and
wherein, in the third-first region, in the direction of the second diameter, two layers of the second-second insulating member are provided.

19. The electrode assembly as claimed in claim 18, wherein the electrode assembly includes a fourth-second region in which two layers of the first insulating member and two layers of the second-second insulating member are provided in the direction of the second diameter.

20. The electrode assembly as claimed in claim 17, wherein a first-second insulating member is further disposed on the second uncoated portion, and
wherein the first-second insulating member is disposed on at least one surface of the second uncoated portion.
